(19) United States
(12) Patent Application Publication
(10) Pub. No.: US 2007/0119967 A1
(43) Pub. Date: May 31, 2007

(54) Gasoline Engine Carburetor Primary Nozzle

(76) Inventor: Qi-An Chen, Ruian City (CN)

Correspondence Address: BANGER SHIA, 204 CANYON CREEK, VICTORIA, TX, 77901-3695, US

(21) Appl. No.: 11/462,977

(22) Filed: Aug. 7, 2006

(30) Foreign Application Priority Data
Oct. 29, 2005 (CN) 200520076939.2

(51) Int. Cl. F02M 47/02; F02M 61/00; F02M 63/00; B05B 1/26

(52) U.S. Cl. 239/88; 239/533.2; 239/533.12; 239/601

(57) ABSTRACT

A gasoline engine carburetor primary nozzle includes a body of the nozzle and a connecting member disposed below the body; a channel being axially disposed between and connecting through both of the body and the connecting member; a spray tip being provided on the sidewall of the body; both of the body and the connecting member being made of the same plastic material and in an integrated part by injection mold in one process to allow simple construction, lower production cost and without getting loosened up forever.

### BACKGROUND OF THE INVENTION

(a) Field of the Invention

The present invention is related to a gasoline engine carburetor primary nozzle.

(b) Description of the Prior Art:

Referring to FIG. 1 of the accompanying drawings for a U.S. Pat. No. 5,599,484A, a carburetor nozzle is comprised of a copper connecting member 2′ and a nozzle body 1′; and a channel is axially disposed between and connecting through both of the connecting member 2′ and the nozzle body 1′. Whereas the connection between the cooper connecting member 2′ and the nozzle body 1′ is achieved by having the former to be inserted into the lower end of the latter, it is comparatively tedious and involves higher production cost since the connecting member 2′ is made of copper. Furthermore, both are made of different materials (metal and plastic) and they have different expansion coefficients to liable to loosening up after use for a certain period of time.

### SUMMARY OF THE INVENTION

The primary purpose of the present invention is to provide a carburetor primary nozzle for gasoline engine to correct the defects found with the prior art that is simple in construction, allowing cost reduction and never gets loosened up.

To achieve the purpose, the present invention is comprised of a body of the primary nozzle and a connecting member disposed below the body of the primary nozzle; a channel is axially disposed between and connecting through both of the body of the primary nozzle and the connecting member; and a spray tip connecting through the channel is disposed on the side wall of the primary body of the nozzle. Wherein, both of the body of the primary nozzle and the connecting member are made in an integral part. The spray tip may be made in a form of a triangle, diamond or oval; or alternatively, in a form comprised of a triangle in the upper part and a square in the lower part of the tip.

Whereas the primary nozzle of the present invention is made an integral part to allow mold injection in one process at lower cost and without being liable to get loosened up for good.

### BRIEF DESCRIPTION OF THE DRAWINGS

FIG. 1 is a schematic view showing a construction of the prior art.

FIG. 2 is a schematic view showing a construction of a first preferred embodiment of the present invention.

FIG. 3 is a schematic view showing a spray tip of the first preferred embodiment of the present invention.

FIG. 4 is a schematic view showing a spray tip of a second preferred embodiment of the present invention.

FIG. 5 is a schematic view showing a spray tip of a third preferred embodiment of the present invention.

FIG. 6 is a schematic view showing a spray tip of a fourth preferred embodiment of the present invention.

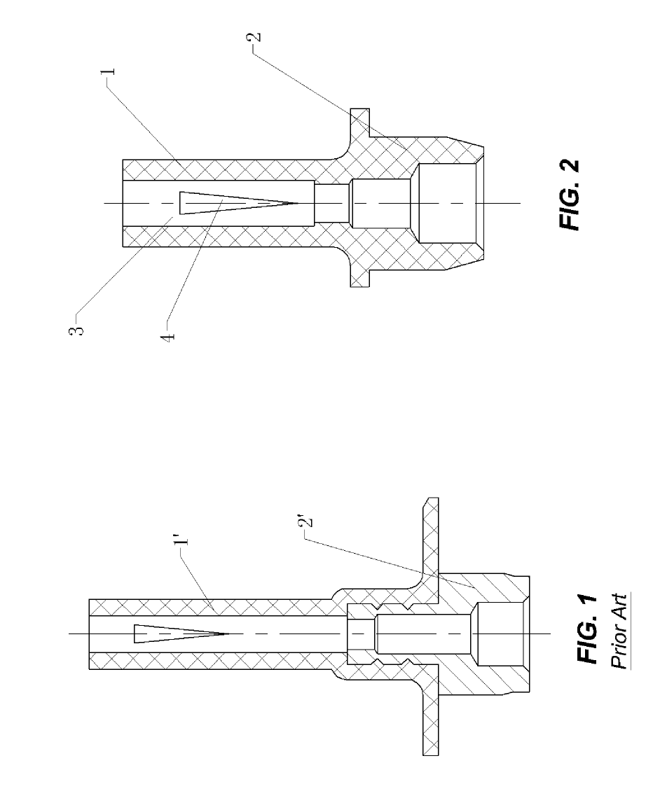

### DETAILED DESCRIPTION OF THE PREFERRED EMBODIMENTS

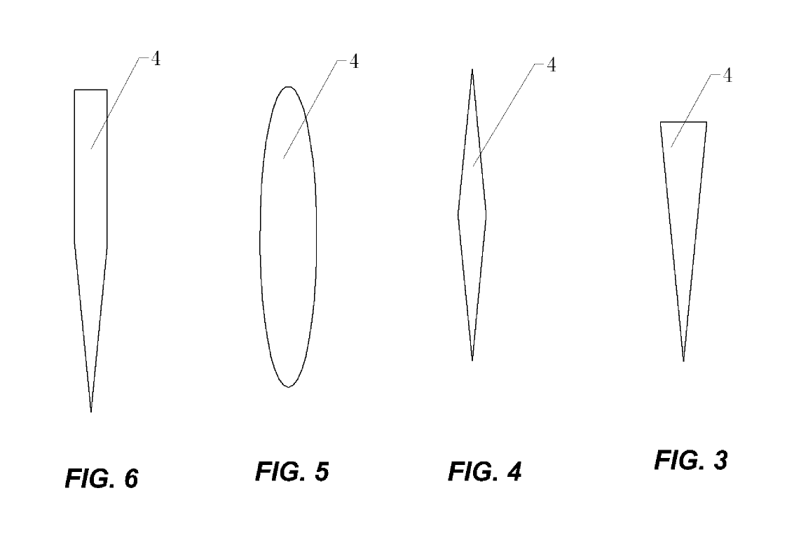

Referring to FIG. 2, a preferred embodiment of the present invention includes body 1 of the primary nozzle and a connecting member 2 disposed below the primary nozzle body 1. A channel 3 axially disposed between and connecting through the primary nozzle body 1 and the connecting member 2. A spray tip 4 connecting through the channel is disposed on the sidewall of the primary nozzle body 1. Both of the primary nozzle body 1 and the connection member 2 are made of the same type of plastic material and is molded by injection into an integral part. As illustrated in FIGS. 3 through 6, the spray tip 4 may be made in a form of a triangle, diamond, or oval. Alternatively, the spray tip 4 is made in a combined form of a triangle lower part and a square upper part.

I claim:

1. A gasoline engine carburetor primary nozzle includes a body of the primary nozzle and a connecting member disposed below the body of the primary nozzle; a channel being axially disposed between and connecting through both of the body of the primary nozzle and the connecting member; a spray tip being provided on the sidewall of the body of the primary nozzle; both of the body of the primary nozzle and the connecting member being made of the same type of plastic material and in an integrated part by injection mold.

2. The gasoline engine carburetor primary nozzle as claimed in claim 1, wherein the spray tip is made in the form of a triangle.

3. The gasoline engine carburetor primary nozzle as claimed in claim 1, wherein the spray tip is made in the form of a diamond.

4. The gasoline engine carburetor primary nozzle as claimed in claim 1, wherein the spray tip is made in a form of an oval.

5. The gasoline engine carburetor primary nozzle as claimed in claim 1, wherein the spray tip is made in a combined form of a triangle lower part and a square upper part.
